(19) United States
(12) Patent Application Publication
(10) Pub. No.: US 2025/0060072 A1
(43) Pub. Date: Feb. 20, 2025

(54) CRYOGENIC FLUID STORAGE UNIT

(71) Applicant: Faurecia Hydrogen Solutions France, NANTERRE (FR)

(72) Inventors: Frédéric GREBER, ECOT (FR); Yannick FOURCAUDOT, LUZE (FR)

(21) Appl. No.: 18/720,728

(22) PCT Filed: Dec. 21, 2022
(86) PCT No.: PCT/EP2022/087365

§ 371 Date: Jun. 17, 2024

(30) Foreign Application Priority Data
Dec. 22, 2021 (FR) FR2114209

(51) Int. Cl. F17C 3/04; F17C 3/08

(52) U.S. Cl. CPC F17C 3/04; F17C 3/08; F17C 2201/0109; F17C 2203/0304; F17C 2203/0395; F17C 2203/0629; F17C 2221/012; F17C 2221/014; F17C 2221/017; F17C 2221/033; F17C 2223/0161; F17C 2265/066; F17C 2270/0105; F17C 2270/0171; F17C 2270/0173; F17C 2270/0176; F17C 2270/0178; F17C 2270/0184

(57) ABSTRACT

A cryogenic fluid storage unit comprises:
an internal reservoir, internally delimiting a storage volume for storing the cryogenic fluid, and
an external reservoir inside which the internal reservoir is arranged. An intermediate space separates the internal reservoir from the external reservoir. A thermal insulation is interposed between the internal reservoir and the external reservoir. A a getter is received in a volume in fluidic communication with the intermediate space, and
the external reservoir has an opening for extracting the getter, and a removable cover closes the opening.

### CROSS-REFERENCE TO RELATED APPLICATIONS

This application is the US national phase of PCT/EP2022/087365, which was filed on Dec. 21, 2022 claiming the benefit of French Application No. 21 14209, filed on Dec. 21, 2021, which is incorporated herein by reference in its entirety.

### TECHNICAL FIELD

The present disclosure relates in general to a cryogenic fluid storage unit, in particular the storage of liquid hydrogen.

This cryogenic fluid storage unit, in addition to the present application, is protected by the following applications, filed the same day, and relating to the following aspects:
an application relating to a hydrogen storage and supply device comprising a method or mechanism for heating the cryogenic fluid leaving the internal reservoir, before supplying a heat exchanger, said method or mechanism being an alternative to that of the present application: said application bears the internal reference FR2114229;
another application also relating to a hydrogen storage and supply device comprising a method or mechanism for heating the cryogenic fluid leaving the internal reservoir, before supplying a heat exchanger, said method or mechanism being an alternative to that of the preceding request: said application bears the internal reference FR2114228;
an application relating to a unit for storing a cryogenic fluid comprising a metal suspension of the internal reservoir from the external reservoir: said application bears the internal reference FR2114255;
an application for an assembly comprising a cryogenic fluid storage unit and a cryogenic valve: said application bears the internal reference FR2114242;
an application relating to a cryogenic fluid storage unit comprising at least one additional reservoir for extending the dormancy time: said application bears the internal reference FR2114234.

### BACKGROUND

It is possible to store liquid hydrogen in a storage unit comprising an internal reservoir delimiting a receiving volume for the liquid hydrogen, and an external reservoir inside which the internal reservoir is arranged.

An intermediate space is thus provided between the internal reservoir and the external reservoir.

The hydrogen is stored in the liquid state in the internal reservoir. To do this, if the gas pressure inside the internal reservoir is at ambient pressure, dihydrogen, commonly called hydrogen, must be kept at a temperature close to 20 K.

Thermal insulation is arranged in the intermediate space. This thermal insulation is typically composed of several layers of fine metal sheets, and layers of fibers inserted between the metal sheets.

The thermal insulation is placed over the internal reservoir, without touching the external reservoir.

The intermediate volume is placed under a high vacuum, in order to limit as much as possible the heat transfer by convection between the two reservoirs. The high vacuum is typically of the order of 10-5 millibars.

In order to obtain a high vacuum in the intermediate space, and in a lasting manner, the storage unit is subjected to the following procedure before being placed in service.

A thorough cleaning and drying of the storage unit components is carried out before the assembly of the components.

Then, the intermediate space is subjected to a degassing operation. The gas contained in the intermediate space between the two reservoirs is pumped out. As the pressure decreases, water, fats and gases contained in the material in contact with the vacuum evaporate.

The degassing operation is carried out by circulating a neutral gas such as nitrogen in the intermediate space, at low pressure, and subjecting the storage unit to one or more heating and cooling cycles. This degassing phase lasts between two days and two weeks.

At the end of the degassing phase, a getter is placed in the intermediate space.

“Getter” is understood here to mean a member containing a substance having the ability to absorb gases such as in particular water vapor and dihydrogen, in a volume subjected to vacuum. The getter may also be called a “gas absorber”.

Finally, the intermediate space is placed under vacuum and sealed.

The getter is provided to absorb the very small quantities of gas which will be released from the intermediate space during the life of the storage unit.

Indeed, despite the care given to the degassing operations, gases remain trapped either at the surface of the storage components or in the material constituting these components, or between the different layers of the thermal insulation.

In particular, the stainless steel constituting the internal reservoir and the external reservoir contains hydrogen, as well as all the metal parts forming the functional members of the storage unit. It is difficult to completely extract this hydrogen during the degassing phase.

These gases also come from micro-holes in the welds or in the assemblies, which will allow very small quantities of air coming from the outside or hydrogen coming from the internal reservoir.

The lifetime of such a storage unit is fifteen years or more. The high vacuum must be kept as long as possible in order to permanently limit heat transfer by convection between the external reservoir and the internal reservoir.

After several years of operation, it was observed that the pressure in the intermediate space between the two reservoirs increases, despite the presence of the getter.

This increase in pressure leads to an increase in heat transfer by convection between the internal reservoir and the external reservoir. These transfers become problematic when the internal pressure exceeds 10-3 millibars.

In the event of air leaking from outside the storage unit into the intermediate space, the incoming air will liquefy in contact with the wall of the internal reservoir. This inner wall is at a temperature of about 20 K, that is to say at a temperature below the liquefaction temperature of nitrogen and oxygen. In parallel, the hydrogen contained in the internal reservoir will be heated because the thermal insulation is degraded. This will lead to an increase in the internal pressure of the internal reservoir.

The internal reservoir is equipped with a vent, which opens once the pressure inside the internal reservoir has exceeded the calibration value of the vent. Since the internal reservoir is not adiabatic, without drawing off the contained hydrogen, the temperature and therefore the pressure will increase until the vent is opened when the pressure reaches the calibration pressure.

In the event of sudden failure of the vacuum, the liquid hydrogen will quickly be heated and therefore the internal pressure will increase rapidly. The vent will open and the hydrogen will go into the atmosphere. As the internal reservoir empties, the internal reservoir temperature increases until it reaches a temperature of 77 K, corresponding to the boiling temperature of the air. The change of temperature of the internal reservoir wall from 20 K to 77 K will cause a sudden boiling of air, which could lead to the damage of the external reservoir.

In this context, the disclosure aims to propose a cryogenic fluid storage unit, wherein maintaining a high vacuum in the intermediate space separating the internal reservoir from the external reservoir is facilitated.

### SUMMARY

To this end, the disclosure relates to a cryogenic fluid storage unit, comprising:
an internal reservoir, which internally delimits a storage volume for storing the cryogenic fluid;
an external reservoir inside which the internal reservoir is arranged, wherein an intermediate space separates the internal reservoir from the external reservoir;
thermal insulation interposed between the internal reservoir and the external reservoir;
a getter received in a volume in fluidic communication with the intermediate space;
the external reservoir having an opening for extracting the getter, and a removable cover closing the opening.

Because the external reservoir has an opening for extracting the getter, it is possible to replace the getter easily during storage life.

The getter may be reactivated or replaced by a new getter.

More specifically, when the vacuum in the intermediate space has become too low, the internal reservoir is emptied of cryogenic fluid. The intermediate space is placed at ambient pressure, and the getter is extracted through the opening provided for this purpose in the external reservoir.

If necessary, the leaks that led to the failure of the vacuum are repaired.

If necessary, the intermediate space is subjected to a simplified degassing procedure.

A new getter, or regenerated getter, is reinstalled in the intermediate space, and the high vacuum is restored in the intermediate space.

The original getter, having gone through a vacuum failure, even partial, would probably be completely saturated. Even if it had not, it would be very quickly saturated in contact with air when the intermediate space is brought to ambient pressure. Exposing the original getter to the vacuum does not allow it to be regenerated, and involves degassing in the intermediate space.

Indeed, typically, gas absorbers are reactivated by heating at high temperatures, between 750° C. and 900° C., under vacuum. Such reactivation is not possible if the getters are left in place.

If no opening is provided for this purpose in the external reservoir, the extraction of the getter outside the intermediate space requires the storage unit to be deconstructed, which is a complex operation to carry out.

The storage unit may further comprise one or more of the following features, considered alone or according to any technically possible combinations:
the internal reservoir comprises an inner tubular wall having a central axis, and first and second inner bottoms closing opposite axial ends of the inner tubular wall, the internal reservoir further comprising a tube and securing the first and second inner bottoms to one another, the getter being received in the tube;
the tube has a first end part protruding outside the internal reservoir through the first inner bottom, the getter being received in the first end part;
the external reservoir comprises an outer tubular wall having a central axis, and first and second outer bottoms closing opposite axial ends of the outer tubular wall, the first outer bottom extending opposite the first inner bottom, the opening being provided in the first outer bottom, axially in line with the first end portion of the tube;
the thermal insulation is arranged against the internal reservoir and the tube passes through said insulation, the tube having at least one orifice opening into a thickness of the thermal insulation;
the getter has an external cross-section smaller than an internal cross-section of the tube, such that a circulation of gas is possible along the tube at the getter level;
the getter comprises a gas-absorbing material and a support rod passing through the gas-absorbing material, the getter being attached to the tube by two plates cooperating with two opposite end parts of the support rod;
the plates are perforated, a flow of gas being permitted through the plates;
the getter comprises a gripping member protruding from the tube;
the cover has a weakened zone.

### BRIEF DESCRIPTION OF THE DRAWINGS

Other features and advantages of the disclosure will become apparent from the detailed description given hereunder, solely for illustrative purposes, with reference to the appended figures, among which:

FIG. 1 is an axial sectional view of the storage unit of the disclosure;

FIG. 2 is an enlarged view of a detail of FIG. 1, showing the getter:

FIG. 3 is a perspective view of the getter of FIGS. 1 and 2; and

FIG. 4 is a perspective view of the cover of the storage unit of FIGS. 1 and 2.

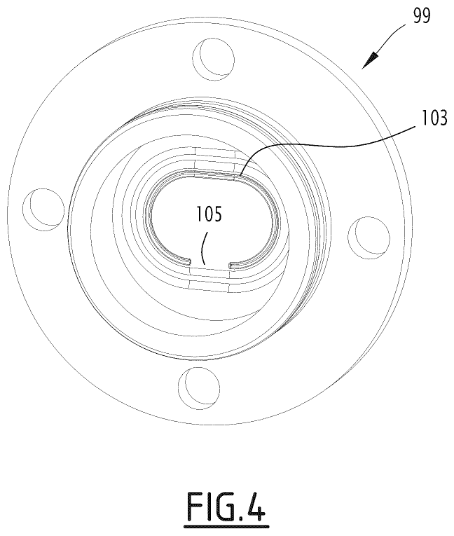

### DETAILED DESCRIPTION

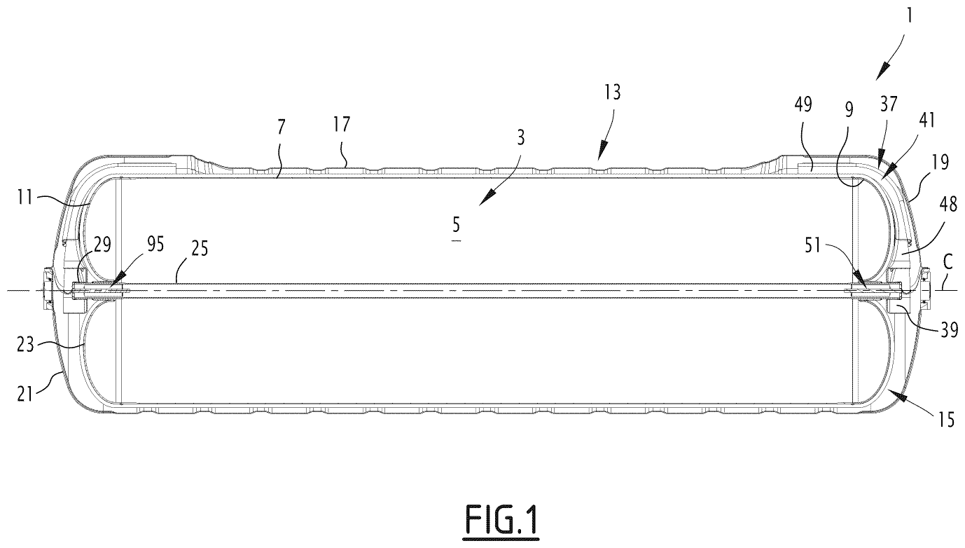

The storage unit 1 shown in FIG. 1 is intended to store a cryogenic fluid.

“Fluid” here means an element that can be in one of the gaseous, liquid or supercritical states.

“Cryogenic fluid” refers to a fluid at a temperature below 120 K.

This fluid is at least partially in the liquid state inside the storage unit.

This fluid is typically hydrogen, preferably gaseous hydrogen. Alternatively, the fluid is helium, nitrogen, natural gas such as methane CH4 or any other suitable fluid.

The storage unit 1 is typically intended to be installed on board a vehicle, typically a train, a ship, or a motor vehicle such as a car, a truck, a bus, etc.

In this case it is intended to supply a fuel cell, producing electricity for an electric motor. This electric motor is typically the vehicle's propulsion motor.

When the fluid is hydrogen, it is stored in the storage unit 1 for example, at ambient pressure and at a temperature close to 20 K.

As can be seen in FIG. 1, the storage unit 1 comprises an internal reservoir 3, internally delimiting a storage volume 5 intended to receive the cryogenic fluid.

The internal reservoir 3 comprises an inner tubular wall 7 having a central axis C, and first and second inner bottoms 9, 11 closing opposite axial ends of the inner tubular wall 7.

Typically, the inner tubular wall 7 has, perpendicular to the central axis C, a constant cross-section. This cross-section is for example circular.

In the normal position of use of the storage unit 1, the central axis C is horizontal.

The storage unit 1 further comprises an external reservoir 13, inside which the internal reservoir 3 is arranged.

The external reservoir 13 has no direct contact with the internal reservoir 3.

An intermediate space 15 separates the internal reservoir 3 from the external reservoir 13.

The external reservoir 13 comprises an outer tubular wall 17 having a central axis, and first and second outer bottoms 19, 21 closing opposite axial ends of the outer tubular wall 17.

Typically, the external reservoir 13 is coaxial with the internal reservoir 3. In other words, the central axis of the external reservoir 13 is the axis C.

The outer tubular wall 17 is placed around and opposite the inner tubular wall 7. The first and second outer bottoms 19, 21 are placed opposite the first and second inner bottoms 9, 11.

The storage unit 1 further comprises a thermal insulation 23, interposed between the internal reservoir 3 and the external reservoir 13.

It is placed in the intermediate space 15.

The thermal insulation 23 is arranged against the internal reservoir 3.

More precisely, it is placed against an external surface of the internal reservoir 3.

The thermal insulation 23 typically comprises a plurality of fine metal sheets superimposed on one another, and layers of fibers inserted between the metal sheets.

This thermal insulation 23 completely surrounds the internal reservoir 3.

The internal reservoir 3 further comprises a tube 25 extending along the central axis C and securing the first and second inner bottoms 9, 11 to one another.

The tube 25 extends inside the internal reservoir 3, and passes through it over its entire axial length.

The tube 25 is hollow. It is open at both ends thereof and internally delimits a passage through which the zone of the intermediate space located between the first inner bottom 9 and the first outer bottom 19 communicates with the zone of the intermediate space located between the second inner bottom 11 and the second outer bottom 21.

The tube 25 has a first end part 27 protruding outside the internal reservoir 3 through the first inner bottom 9.

It also comprises a second end part 29 protruding outside the internal reservoir 3 through the second inner bottom 11.

An orifice 31 is provided in the first inner bottom 9.

A sleeve 33, of tubular shape, is engaged in the orifice 31 and is attached to the first inner bottom 9 in a sealed manner.

The first end part 27 of the tube 25 is received in the sleeve 33 and passes through it over its entire length.

In the example shown in the figures, the orifice 31 is formed by a part of the first inner bottom 9 forming a neck 35 entering into the internal reservoir 3.

The second inner bottom 11 has an orifice of the same type into which another sleeve, not referenced, is inserted. The second end part 29 of the tube 25 is engaged in said other sleeve.

The storage unit 1 further comprises a suspension 37, the internal reservoir 3 being suspended from the external reservoir 13 by the suspension 37.

The suspension 37 is of any suitable type.

In the example shown, the suspension 37 connects the first and second end parts 27, 29 of the tube 25 to the outer tubular wall 17.

More specifically, it connects the end parts 27, 29 of the tube 25 to the upper part of the outer tubular wall 17.

To do this, the suspension 37 comprises, for each end part 27, 29 of the tube 25, a stamped plate 39 and one or more bent arms 41.

The stamped plate 39 has a planar zone 43 in which an orifice 45 delimited by a flanged edge 47 is provided.

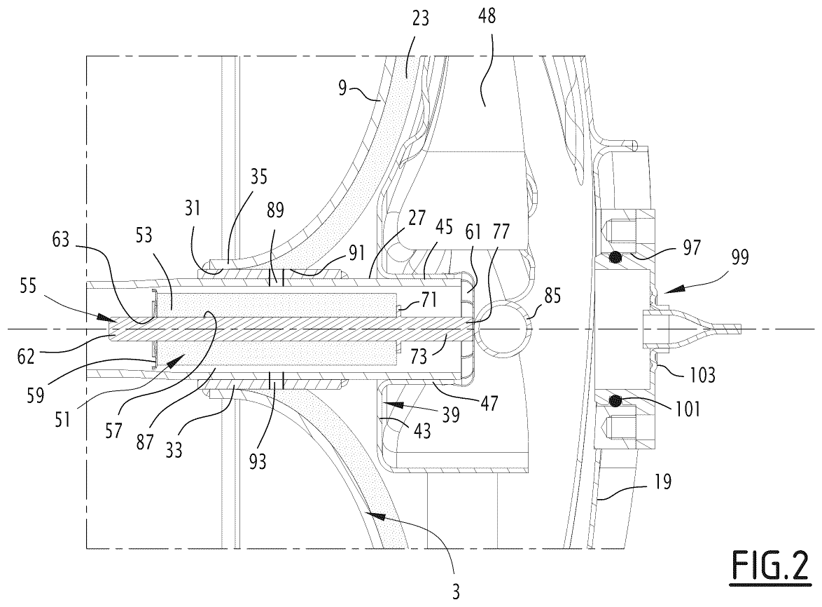

As can be seen in FIG. 2, the first end part 27 is engaged in the orifice 45. The flanged edge 47 is rigidly attached to the first end part 27.

The end edges of the flanged edge 47 and of the first end part 27 are substantially level.

One segment 48 of each bent arm 41 extends substantially radially relative to the central axis C and is rigidly attached to the stamped plate 39. Another end part 49 of the bent arm 41 extends substantially parallel to the central axis C and is engaged between the inner tubular wall 7 and the outer tubular wall 17. It is rigidly attached to the outer tubular wall 17.

The second end 29 of the tube 25 is suspended from the external reservoir 13 in the same way.

The storage unit 1 further comprises a getter 51 received in a volume in fluid communication with the intermediate space 15.

This means that the getter 51 is received in the intermediate space 15 or in a volume communicating with the intermediate space 15.

Advantageously, the getter 51 is received in the tube 25.

More specifically, the getter 51 is received in the first end part 27 of the tube 25.

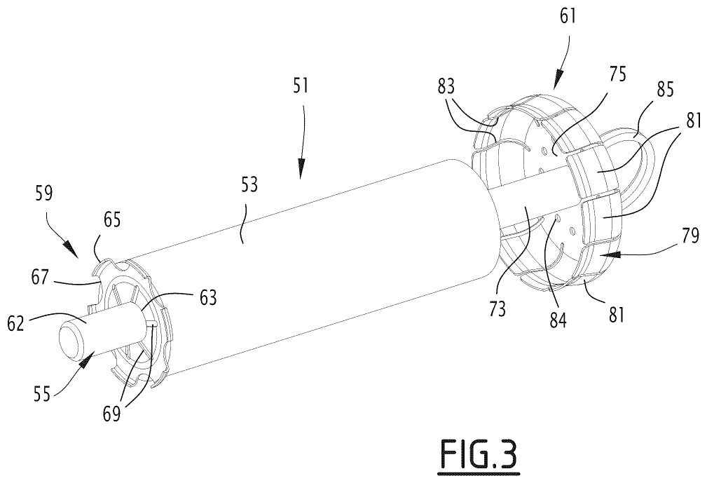

As can be seen in particular in FIG. 3, the getter 51 comprises a gas-absorbing material 53. It also comprises a support rod 55 passing through the gas-absorbing material 53.

The support rod 55 extends along the central axis C.

The gas-absorbing material 53 is of any suitable type.

Typically, it is a sintered powder containing a zeolite, and/or other compounds such as titanium, molybdenum or a nickel-chromium alloy.

The gas-absorbing material 53 typically has a porosity of about 50%.

The gas-absorbing material 53 is in the form of a cylinder with a central passage 57 in which the support rod 55 is received.

As can be seen in particular in FIG. 2, the getter 51 has an external cross-section smaller than an internal cross-section of the tube 25, such that a circulation of gas is possible along the tube 25, inside the tube, to the getter 51.

In other words, there remains a free gap between the radially outer surface of the getter 51 and the inner surface of the tube 25.

The getter 51 is attached to the tube 25 by two plates 59, 61.

The plates 59, 61 are perforated, a flow of gas being allowed through the plates 59, 61.

In the example shown, the getter 51 is attached to the tube 25 by two plates 59, 61, cooperating with two opposite end parts of the support rod 55.

The plate 59 is arranged on the distal end part 62 of the support rod 55, that is to say the end part inserted furthest inside the tube 25.

The plate 59 is generally cup-shaped. It has a central orifice 63, by means of which the plate 59 is threaded onto the support rod 55. It also has a folded outer peripheral edge 65, bearing against the inner surface of the tube 25. Notches 67 are cut into the outer peripheral edge 65. Other notches 69 are cut into the central part of the plate 59, and extend for example radially from the central orifice 63.

The plate 59 is rigidly attached to the support rod 55, by any suitable means, for example by welding.

It should be noted that a circumferential rib 71 is formed on the support rod 55. An axial end of the gas-absorbing material 53 bears axially against the rib 71. The opposite axial end of the gas-absorbing material 53 bears axially against the plate 59.

Thus, the gas-absorbing material 53 is engaged axially between the rib 71 and the plate 59, and is held in position along the support rod 55.

At its end opposite the plate 59, the support rod 55 stops axially substantially at the same level as the tube 25 and the flanged edge 47. The plate 61 is mounted on this proximal end part 73.

The plate 61 is also generally cup-shaped. It has a substantially planar central part 75, in which an orifice 77 receiving the proximal end part 73 is cut.

It also has a folded outer peripheral edge 79.

The folded edge 79 is subdivided into a plurality of tabs 81 by slits 83 spaced circumferentially around the central axis C. The slits 83 emerge at the free edge of the plate 61, and extends into the central part 75 of the plate 61. They are closed at the central part 75. The edge 79 bears on a radially outer surface of the flanged edge 47. Thus, the end of the tube 25 and the flanged edge 47 are housed inside the plate 61.

The tabs 81 constitute spring blades elastically biased against the flanged edge 47, and are not rigidly attached thereto.

The central part 75 of the plate 61 is pierced by holes 84.

The plates 59 and 61 are generally oriented substantially perpendicular to the central axis C.

As can be seen in FIGS. 2 and 3, the getter 51 further comprises a gripping member 85 protruding outside the tube 25.

In the example shown, the gripping member 85 is a ring, rigidly attached to the proximal end part 73 of the support rod 55. The ring 85 is located outside the tube 25.

The getter 51 is therefore in the form of a cartridge removably engaged in the first end part 27 of the tube 25. The distal end part 62 of the support rod 55 is centered on the central axis C by the plate 59, bearing against the inner surface of the tube 25. The proximal end part 73 of the support rod 55 is centered on the central axis C by the plate 61, which is elastically engaged around the flanged edge 47.

Because the rod 55 is correctly centered on the central axis C, a gap 87 separates the gas-absorbing material 53 from the inner surface of the tube 25 over its entire periphery.

As can be seen in FIGS. 1 and 2, the thermal insulation 23 is arranged against the internal reservoir 3.

The tube 25 passes through it, the tube 25 having at least one orifice 89 opening into a thickness of the thermal insulation 23. Typically, the tube 25 has a plurality of orifices 89, distributed circumferentially around the central axis C.

More specifically, the thermal insulation 23 is pressed onto the external surface of the internal reservoir 3. In particular, it is pressed against the outer surface of the portion of the internal reservoir defining the neck 35.

An opening 91 is formed in the thermal insulation 23, in the extension of the orifice 31. In other words, the opening 91 coincides with the orifice 31.

As indicated above, the thermal insulation 23 is formed of a plurality of metal sheets and a plurality of layers of fibers, superimposed on one another. The opening 91 is cut and passes through each of the metal sheets and each of the layers of fibers. Thus, the interstices separating the sheets and the layers each open into the opening 91, thus allowing the residual gases blocked in these interstices to flow to the opening 91.

The sleeve 33 is engaged through the opening 91.

The sleeve 33 passes through the entire thickness of the thermal insulation layer 23. It has one or several holes 93, placed to coincide with the orifice(s) 89 of the tube 25. Thus, the internal volume of the tube 25 communicates with the interstices separating the sheets and the layers of the thermal insulation 23, through the orifice(s) 89 and the hole(s) 93.

Preferably, the cryogenic fluid storage unit comprises another getter 95, received in the second end part 29 of the tube 25.

The other getter 95 is of the same type as the getter 51, and will therefore not be described in detail here.

It is arranged in the second end part 29 of the tube 25 in the same way as the getter 51 is arranged in the first end part 27 of the tube 25.

Advantageously, the external reservoir 13 comprises an opening 97 for extracting the getter 51, and a removable cover 99 closing the opening 97.

The opening 97 is provided in the first outer bottom 19, axially in line with the first end part 27 of the tube 25.

In other words, the opening 97 is located exactly opposite the getter 51.

The opening 97 has an internal cross-section slightly greater than the external cross-section of the getter 51, taken perpendicular to the central axis C.

As can be seen in FIG. 2, the gripping member 85 is located in the immediate proximity of the opening 97, so an operator can easily insert a hand through the opening 97 to grip the gripping member 85 and extract the getter 51 from the tube 25 along an axial movement.

A seal 101 is interposed between the cover 99 and the edge of the extraction opening 97.

The cover 99 is removably attached to the external reservoir 13 by any suitable method or mechanism, here by screws.

Advantageously, the cover 99 has a weakened zone 103.

The weakened zone 103 is for example a C-shaped line, the two ends of the C being separated by a non-weakened zone 105. In the weakened zone 103, the material constituting the cover 99 is weakened by any suitable method or mechanism: reducing the thickness of the material constituting the cover, deformation of this material, etc.

In the unweakened zone 105, the cover 99 is advantageously reinforced, for example by stiffeners.

Thus, the cover 99 has a zone which, in the event of overpressure in the intermediate space 15, will tear, allowing the pressurized gas to be discharged from the intermediate space 15. The unweakened zone 105 acts as a hinge, thus making it possible to control the deformation of the cover 99 at the time of tearing.

The getter replacement procedure 51 is very simple.

The cryogenic gas stored in the internal reservoir 3 is first evacuated.

The intermediate space 15 is then returned to ambient pressure by any suitable method or mechanism.

The cover 99 is separated from the external reservoir 13, thus freeing the extraction opening 97.

The getter 51 is extracted from the intermediate space 15 through the extraction opening 97.

To do this, the operator inserts his hand into the extraction opening 97 and grips the gripping member 85. He pulls axially on the getter 51. The plate 61 disengages from the flanged edge 47. The plate 59 slides on the inner surface of the tube 25, to the end of this tube 25.

The getter 51 is then regenerated, or a new getter is supplied.

If necessary, a new degassing phase is carried out.

Then, the intermediate space 15 is again filled with air and the regenerated getter 51 is reinstalled, or the new getter is installed. This is done very easily, by removing the cover 99 once again and inserting the getter 51 into the end of the tube 25.

The getter 51 is installed in an axial movement, the plate 59 sliding on the inner surface of the tube 25 until the plate 61 is placed around the flanged edge 47. The cover 99 is then reattached in a sealed manner to the external reservoir 13.

The high vacuum is then restored in the intermediate space 15.

The storage unit described above may have multiple variants.

The thermal insulation is not necessarily of the type described above. It is not necessarily composed of a multitude of metal sheets superimposed on one another, with interposition of layers of fibers. It could consist of another material.

The internal reservoir and the external reservoir could have any shape, and do not necessarily have general cylindrical shapes.

The getter is not necessarily received in the tube 25. It could be received at any point in the intermediate space, provided that the extraction opening is arranged opposite. It could be received not in an end part but in a central section of the tube.

The getter may not be a cartridge of the type described above, with a central rod and a gripping ring.

The getter could quite simply be a brick of gas-absorbing material placed inside the tube, or at any other point of the intermediate space.

It could be that the cover does not have weakened zones.

The storage unit could comprise only a single getter.

The gas storage unit described above has multiple advantages.

The fact that the getter is accommodated in the tube is particularly convenient. This volume is not used to change functional storage members, for example the cryogenic gas circulation ducts or the suspension.

Furthermore, because the tube is hollow, it places in communication the areas of the intermediate space located axially at both ends of the storage unit. The gas molecules released in these two areas can thus easily circulate to the getter.

The fact of arranging the getter in an end part of the tube makes it easily accessible.

Producing the extraction opening of the getter in the first outer bottom, axially in the extension of the first end of the tube, allows an operator to easily access the getter through the opening.

The fact that the tube has at least one orifice opening into the thickness of the thermal insulation means that the gas molecules trapped in the interstices between the various layers of the thermal insulation can escape from these interstices and be absorbed by the getter. This is particularly important because the water molecules contained in the layers are difficult to extract at the time of the degassing phase. Generally a few water molecules and a few air molecules remain trapped in the fiber layers, at the end of the degassing operation. During the lifetime of the storage these molecules tend to migrate along the interstices between the layers of the thermal insulation, and will be trapped by the gas absorber(s).

The fact that the getter has an external cross-section smaller than the internal cross-section of the tube allows the circulation of the gas along the tube at the getter level.

The getter being formed of a gas-absorbing material and having a support rod passing through this material allows the getter to be in the form of an easily extractable cartridge.

The use of perforated plates to attach the getter to the tube allows convenient attachment, without hindering the circulation of the gas.

The fact that the cover has a weakened zone makes it possible to avoid any damage of the external reservoir in the event of overpressure in the intermediate space. The cover will tear in the weakened zone, allowing the gas to escape from the intermediate space.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A cryogenic fluid storage unit comprising:
an internal reservoir, that internally delimits a storage volume configured to store a cryogenic fluid;
an external reservoir inside which the internal reservoir is arranged, an intermediate space separating the internal reservoir from the external reservoir;
a thermal insulation interposed between the internal reservoir and the external reservoir;
a getter received in a volume in fluidic communication with the intermediate space; and
the external reservoir having an opening to extract the getter, and a removable cover closing the opening.

2. The cryogenic fluid storage unit according to claim 1, wherein the internal reservoir comprises an inner tubular wall having a central axis, and a first inner bottom and a second inner bottoms closing opposite axial ends of the inner tubular wall, the internal reservoir further comprising a tube that secures the first inner bottom and second inner bottoms to one another, the getter being received in the tube.

3. The cryogenic fluid storage unit according to claim 2, wherein the tube has a first end part protruding out of the internal reservoir through the first inner bottom, the getter being received in the first end part.

4. The cryogenic fluid storage unit according to claim 3, wherein the external reservoir comprises an outer tubular wall having a central axis, and a first outer bottom and a second outer bottoms closing opposite axial ends of the outer tubular wall, the first outer bottom extending opposite the first inner bottom, the opening being provided in the first outer bottom, axially in line with the first end part of the tube.

5. The cryogenic fluid storage unit according to claim 2, wherein the thermal insulation is arranged against the internal reservoir and the tube passes through the thermal insulation, the tube having at least one orifice opening into a thickness of the thermal insulation.

6. The cryogenic fluid storage unit according to claim 2, wherein the getter has an external cross-section smaller than an internal cross-section of the tube, such that a circulation of gas is possible along the tube at the getter.

7. The cryogenic fluid storage unit according to claim 2, wherein the getter comprises a gas-absorbing material and a support rod passing through the gas-absorbing material, the getter being attached to the tube by two plates cooperating with two opposite end parts of the support rod.

8. The cryogenic fluid storage unit according to claim 7, wherein the two plates are perforated, a flow of gas being permitted through the two plates.

9. The cryogenic fluid storage unit according to claim 2, wherein the getter comprises a gripping member protruding outside the tube.

10. The cryogenic fluid storage unit according to claim 1, wherein the removable cover has a weakened zone.
